(19) United States
(12) Patent Application Publication
(10) Pub. No.: US 2010/0037153 A1
(43) Pub. Date: Feb. 11, 2010

(54) CHAT AND WEB PAGE INTEGRATION METHOD AND SYSTEM

(76) Inventor: Jarrod C. Rogers, San Diego, CA (US)

Correspondence Address: Jarrod Rogers, 756 York Ct, San Diego, CA, 92109, US

(21) Appl. No.: 12/536,993

(22) Filed: Aug. 6, 2009

Related U.S. Application Data
(60) Provisional application No. 61/086,757, filed on Aug. 6, 2008.

(51) Int. Cl. G06F 3/01; G06F 15/16

(52) U.S. Cl. 715/758; 709/227

(57) ABSTRACT

A system and method for providing chat on a Web page, whereby the chat text and the Web page content are displayed together in the same viewable area within a Web browser, the Web page content that is beneath the Chat text remains viewable, and the Chat text remains viewable even as a user scrolls the Web page or navigates to a new Web page. To prevent Chat boxes from obstructing Web content while Chat is being displayed, the boxes can automatically move to another location when a user moves his or her mouse nearby the area containing the Chat boxes.

### BACKGROUND

The Internet has become an important social communications medium. One of the most popular methods of communication via the Internet is text-based Instant Messaging (“IM” or “Chat”), which is utilized by hundreds of millions of individuals throughout the world. Often, the subject of Chat conversations between Internet users is a particular Web page or Web site. Unfortunately, it is difficult to use both IM or Chat effectively while also browsing different Web pages. For example, conventional Chat is provided in a separate Chat window that may interfere with viewing important parts of the Web page.

### BRIEF DESCRIPTION OF THE DRAWINGS

FIG. 1 is a block diagram showing a system for visual social communication on a Web page through co-browsing in accordance with one embodiment.

FIG. 2 is a screenshot of a Web browser, which has joined a social session and loaded a particular content Web page from a content Web server.

FIG. 3 is a screenshot of the action after Amy sends a chat.

FIG. 4 is a screenshot of the resulting Chat boxes from multiple chats sent.

FIG. 5 is a screenshot of the first Chat box created that has disappeared.

FIG. 6 is a screenshot of the resulting action after the mouse moved over the area which contained the Chat boxes.

FIG. 7 is a screenshot of the action after drawing near the area which contained the Chat boxes.

FIG. 8 is a screenshot of the Chat boxes unaffected during scrolling of the content Web page in the Web browser.

FIG. 9 is a screenshot of the Chat box persisting across Web page loads.

FIG. 10 is a screenshot which demonstrates Chat on a Web page utilizing a Web browser plug-in.

FIG. 11 is a screenshot of the resulting action, displaying a message on the browser viewport on top of a Web page.

### DESCRIPTION

The current invention consists of a system and method for providing Chat on a Web page, where the Chat and the Web page content are displayed together in the same viewable area of a Web browser, the Web page content that is beneath the Chat text remains viewable, and the Chat text remains viewable even as a user scrolls the Web page or navigates to a new Web page.

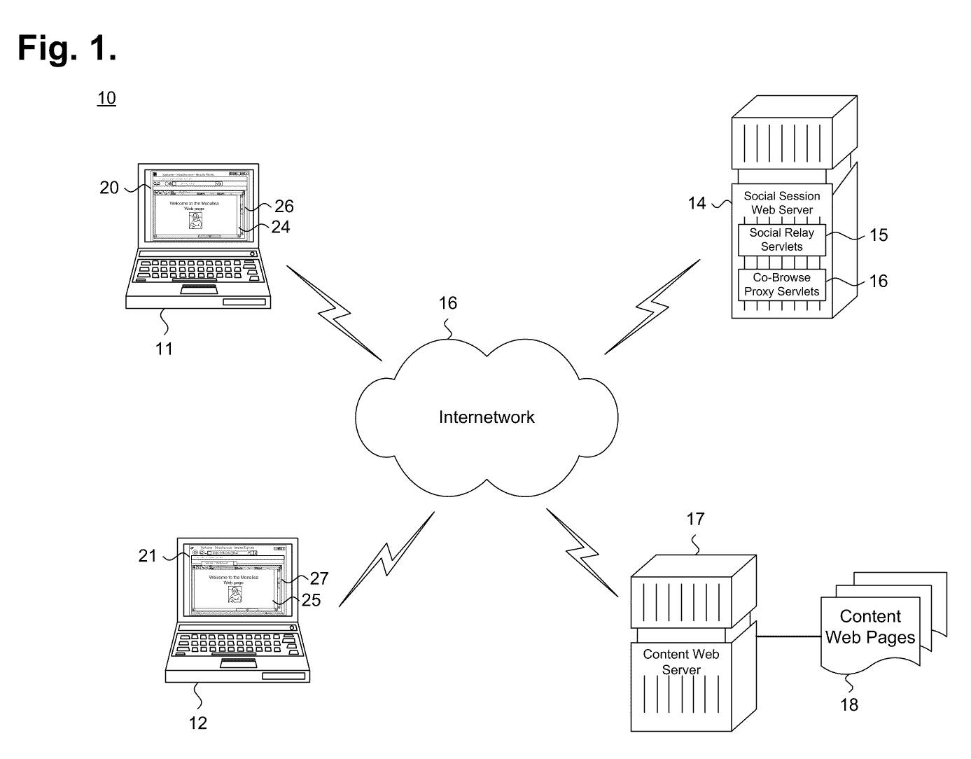

FIG. 1 is a block diagram showing a system for providing Chat on a Web page during a co-browsing session (“social session”) in accordance with one embodiment. A first computer 11, including a Web browser 20 is connected to a Web server (“social session Web server” or “proxy serve”) 14 via an internetwork 16, such as the Internet. A second computer 12 including a Web browser 21 is also connected to the social session Web server 14 via the internetwork 16. The computers 11, 12 can include desktop and notebook computers, as well as handheld devices, including Personal Digital Assistants (PDAs) and cellular telephones. At a minimum, each computer should include a Web browser or similar application and accessibility to an internetwork. In one embodiment, the Web browsers 20, 21 are enabled with JavaScript.

A user joins a social session by loading code (“social session code”) in the Web browser. One embodiment provides that the social session code is contained in a Web page (hereinafter, “social session Web page”) 26, 27 which is loaded in each Web browser 20, 21. The social session Web page 26, 27 is requested from the social session Web server 14. The social session Web page 26, 27 remains loaded on each of the Web browsers 20, 21 throughout the social session. The social session Web page 26, 27 contains a frame in which a requested content Web page 18 is loaded and displayed. The viewable area of the social session Web page 26, 27 which contains the displayed content Web page is hereby referred to as the “social viewport” 24, 25. The content Web page can be any Web page accessible on the internetwork 16. The Web browser 20, 21 sends a request to co-browse proxy-servlets 16, which run on the social session Web server 14, to load the desired content Web page 18. (A servlet is an object that receives a request and generates a response based on that request.) The co-browse proxy servlets 16 receive the request and further request the content Web page 18 from a content Web server 17. The content Web server 17 can be a Web server, which serves Web pages for a particular uniform resource locator (URL).

The co-browse proxy servlets 16 receive the content Web page 18 requested as HyperText Markup Language (HTML). Before transmitting the content Web page 18 to the Web browsers 20, 21, the co-browse proxy servlets 16 edit the hyperlinks and callbacks in the HTML of the content Web page 18, such that the hyperlinks are redirected to the co-browse proxy servlets 16. The co-browse proxy servlets 16 then transmit the processed content Web page 18 to the Web browsers 20, 21 for display within the frame contained in their respective social viewports 24, 25.

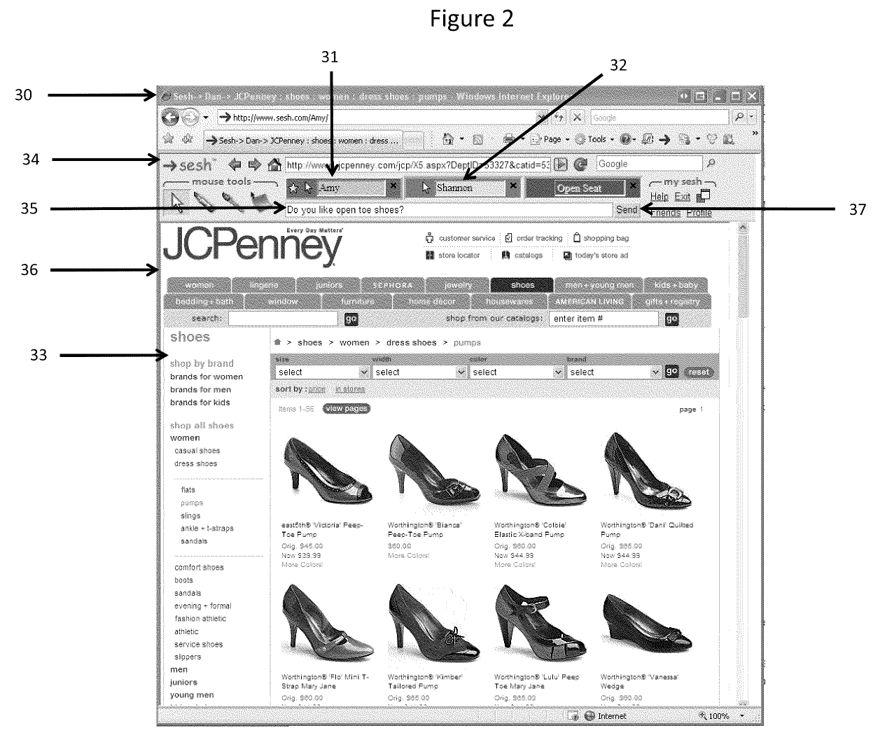

Each user can Chat on the content Web page 18 displayed in his social viewport 24, 25. The Chat is further described with reference to FIGS. 2-11. The Chat text entered into a text box by each user is transmitted to servlets (“social relay servlets”) 15 running on the social session Web server 14. The social relay servlets 15 in turn relay the Chat text to the other Web browsers 20, 21. Each receiving Web browser duplicates the Chat text as a semi-transparent overlay located over the social viewport 24, 25.

FIG. 2 is a screenshot of a Web browser 30, which has joined a social session and loaded a particular content Web page 33 from a content Web server. This Web browser is being utilized by user “Amy” 31. Amy's friend “Shannon” 32 has joined the social session and Shannon's Web browser displays the same content Web page 33, which is displayed within a social viewport 36 of a social session Web page 34. In one embodiment, the users are participating in a synchronized co-browsing session as further described in patent application Ser. No. 12/034,562, entitled “System and Method for Synchronized Co-Browsing” by Jarrod C. Rogers incorporated by reference herein.

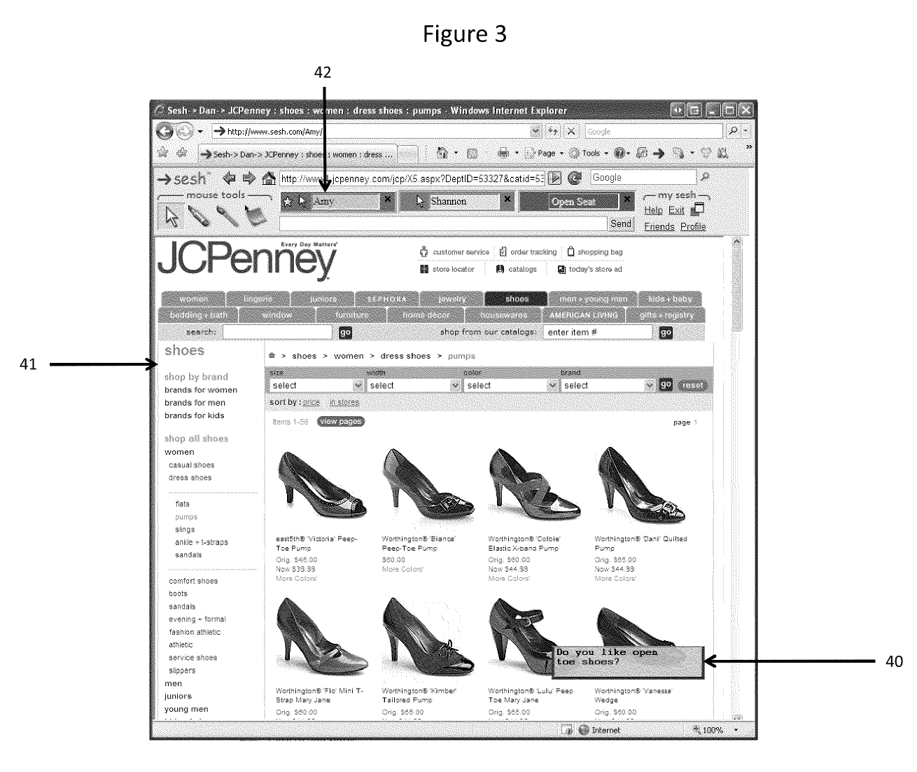

Amy desires to discuss the content Web page 33 with her friend Shannon. The content Web page contains various images of shoes for purchase from JCPenney.com. Amy types “Do you like open toe shoes?” into a text box designated for Chat 35 located on the content Web page 34, and then clicks the “Send” button 37. FIG. 3 is a screenshot of the action that follows. After Amy clicks the “Send” button, the text is displayed in a Chat box 40 that appears as a semi-transparent overlay located over the social viewport 41 of Amy's Web browser. The text is also transmitted to social relay servlets (FIG. 1 at 15), which further transmit the text to the other Web browsers in the social session (i.e., Shannon's Web browser). Shannon's Web browser displays the Chat text in an identical Chat box as a semi-transparent overlay located over the social viewport. The Chat box identifies the text as having come from Amy. In this example, Amy is assigned the color red 42, and the Chat box 40 is thus colored red to identify Amy as the creator of the Chat message. In this example, the Chat boxes are semi-transparent so that the users have a view of the Web content underneath. However, the Chat boxes can be opaque instead of semi-transparent. The size and font of the text displayed in the Chat box can be increased or changed to ensure the text is easily readable on the Web page by a user. The Chat box can expand or collapse to fit the amount or size of the text displayed within it.

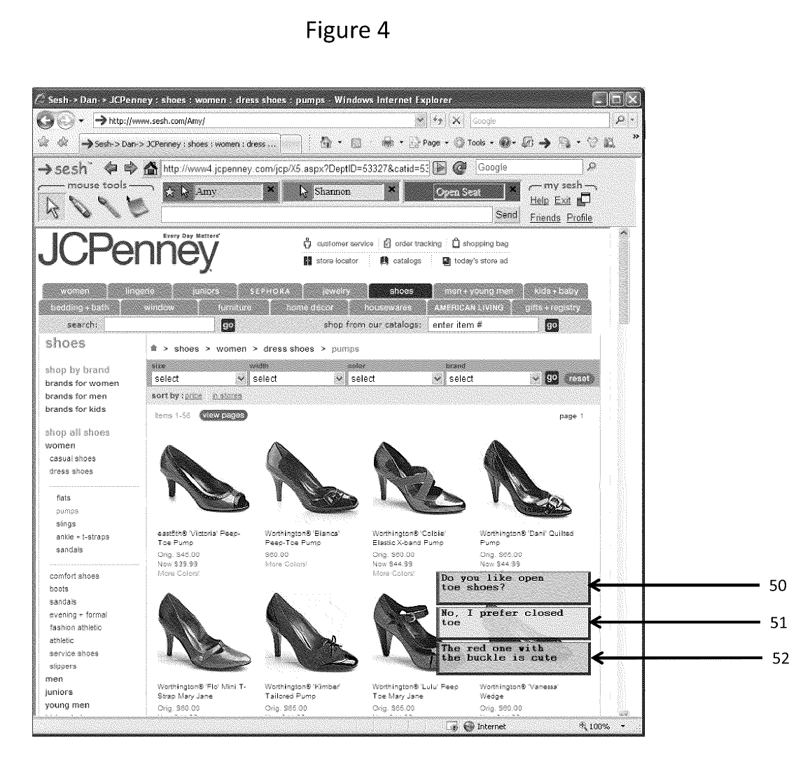

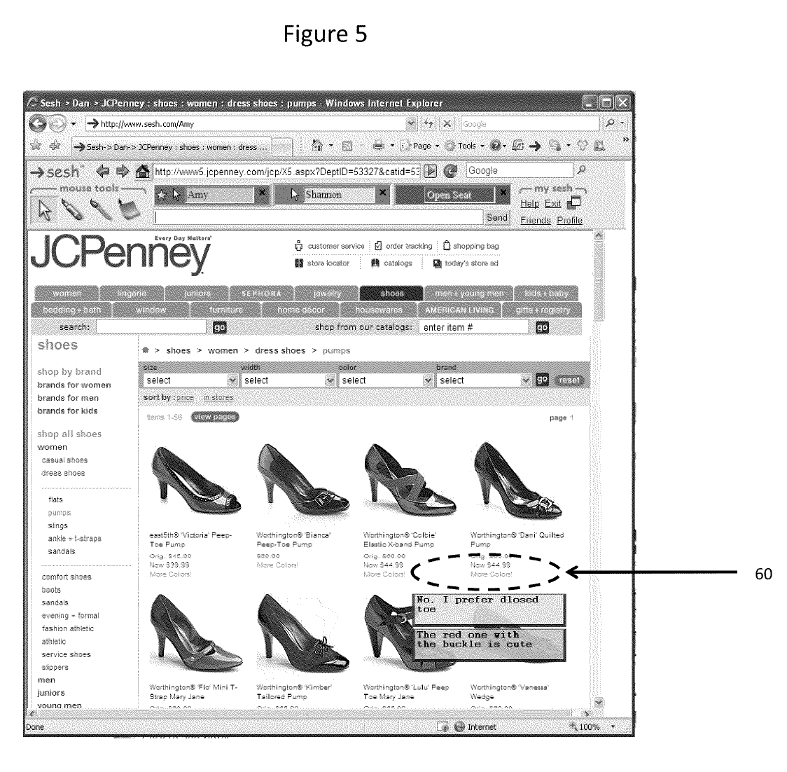

Shannon responds in turn by typing “No, I prefer closed toe” and clicking the “Send” button located on the social session Web page loaded in Shannon's browser. The Chat text is displayed in a Chat box on the social viewport in Shannon's browser, and is also transmitted to and displayed in Amy's browser. Amy then types “The red one with the buckle is cute” and clicks “Send,” initiating a similar process. FIG. 4 is a screenshot of the resulting Chat boxes, as displayed on Amy's Web browser (they are displayed identically on Shannon's Web browser). Each new Chat box appears at the bottom, pushing the prior Chat boxes upwards. The first Chat box 50 moves upwards as Shannon's response 51 appears below it in its place. The Chat box with Shannon's response 51 is colored green (Shannon's assigned color) to identify Shannon as the source. Amy's next Chat message 52 in turn moves boxes 51 and 50 upwards. Each Chat box can disappear after a designated time period, such as 15 seconds, to prevent the boxes from stacking up and cluttering the screen. For example, in FIG. 5, the first Chat box created by Amy (“Do you like open toe shoes?”) has disappeared, as illustrated for the purpose of this discussion with the dashed oval 60, because 15 seconds have elapsed. Other methods of display or stacking of Chat, and different time periods, are possible.

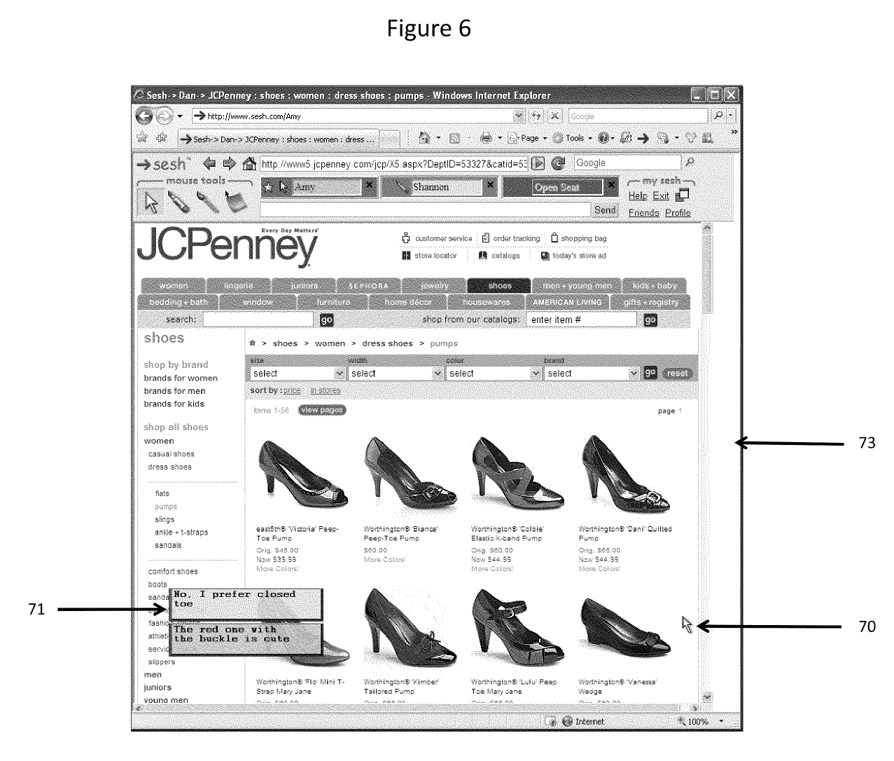

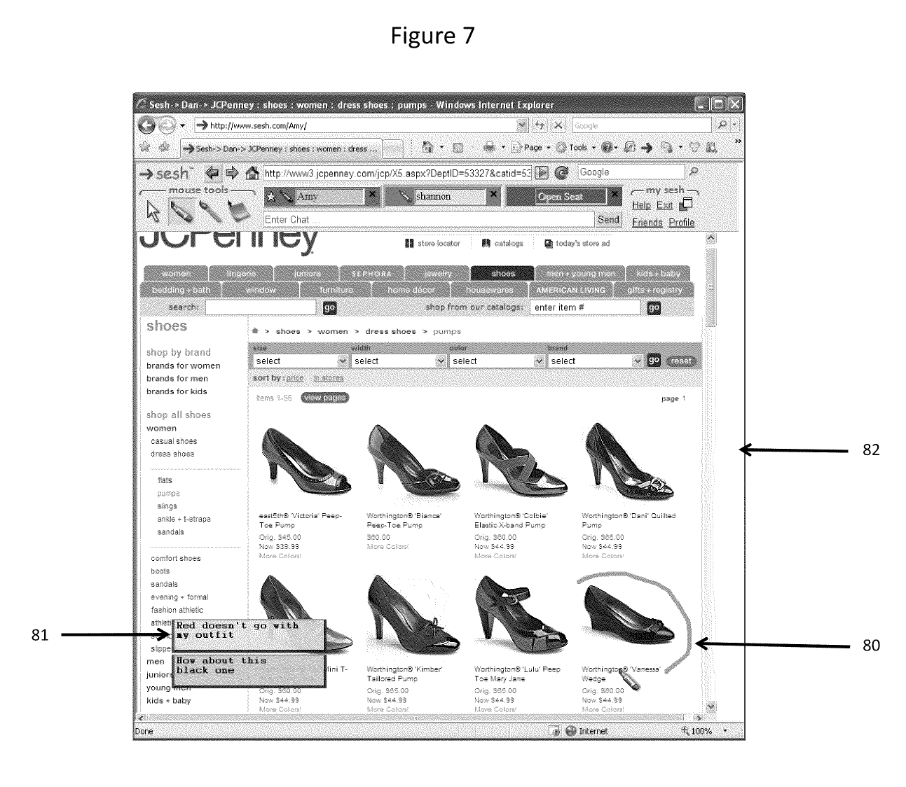

To prevent Chat boxes from obstructing Web content while Chat is being displayed, the boxes can automatically move to another part of the social viewport when a user moves his or her mouse nearby the area containing the Chat boxes. In FIG. 6, Amy moves her mouse over the area on the bottom right of the social viewport 73 which contains the Chat boxes. Upon Amy's moving the mouse (denoted by the mouse pointer 70), the Chat boxes 71 move to the other side of the social viewport 73. Similarly, if Amy performs a drawing action near the Chat boxes (FIG. 7 at 80) on the social viewport 82, the Chat boxes 81 move to the other side of the social viewport 82. (One example of the drawing action is described in patent application Ser. No. 12/034,579, entitled “System and Method for Facilitating Visual Social Communication Through Co-Browsing” by Jarrod C. Rogers, incorporated by reference herein.) The Chat box movement data is transmitted to social relay servlets (FIG. 1 at 15), which further transmit the data to Shannon's Web browser to reproduce the movement on the social viewport of Shannon's browser, so that the Chat boxes do not obstruct the view of the drawing in either Web browser. In this example, the Chat boxes default to display on the bottom right of the social viewport (FIG. 4 at 50, 51, 52), and shift to the bottom left (FIG. 6 at 71). In turn, once they are on the bottom left 71, a mouse or drawing action in that area shifts them back to the bottom right. Other methods of movement and locations for displaying Chat boxes are possible.

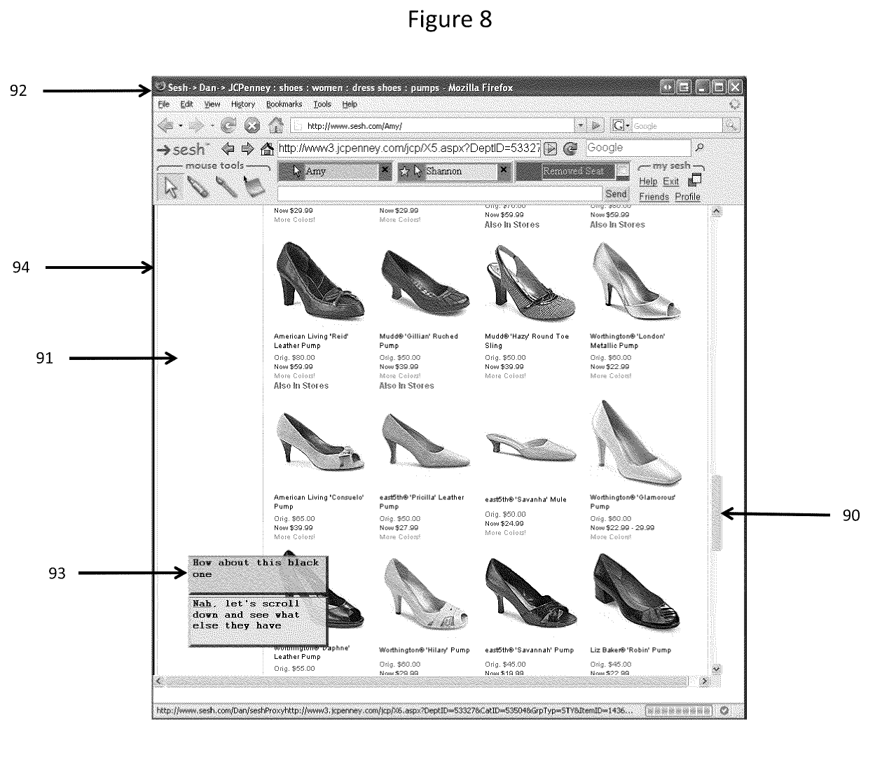

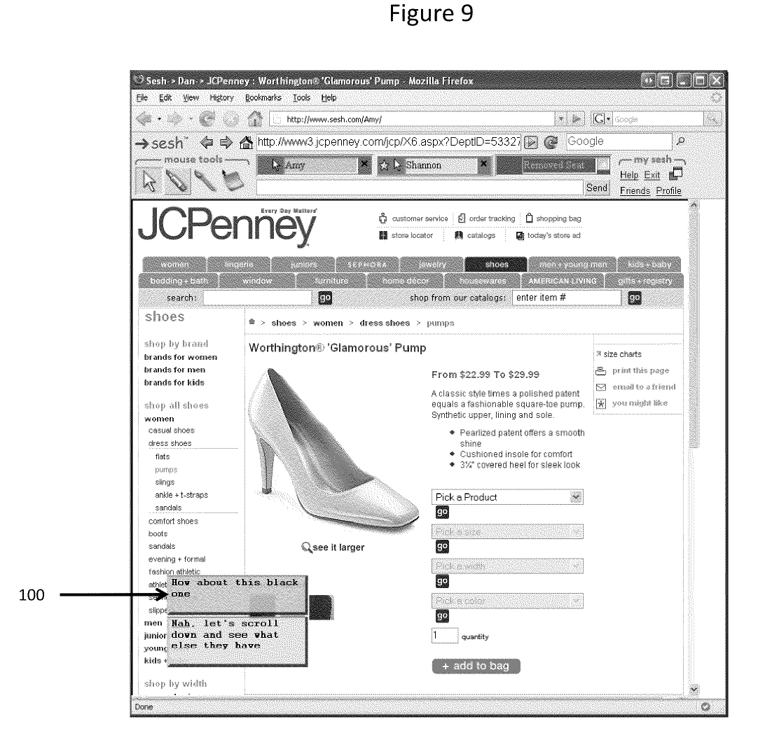

Aspects of the invention enable Chat to remain viewable even as a user scrolls the content Web page. As depicted in FIG. 8, when Shannon scrolls 90 the content Web page 91 in her Web browser 92 to view more shoes, the Chat boxes 93 remain floating in both Web browsers in the same position on the social viewport 94. Similarly, when Shannon clicks to a new page to view a particular shoe, the Chat boxes remain (FIG. 9 at 100). Although the example identifies two Web browser users, other combinations of users and Web browsers are possible.

Other traditional Chat features can be implemented including sound, adding emotions to messages, friends lists, and a detailed Chat history. Such features can be accessible and viewable within the social session Web page, as an overlay over the browser viewport, or in a separate window or browser sidebar. In one embodiment, Chat history can be displayed on the social viewport within the social session Web page. A user can recall and display past Chats, which can be viewable by that user only, or by all users in the social session. Recalling a Chat history can display a floating scrollbar to the right of the area where Chat boxes are normally viewed. A user can scroll through the previous Chat boxes, which appear stacked on top of each other on the social viewport. To enable scrolling while a Chat history is being viewed, the feature to automatically move the Chat boxes out of the way is temporary disabled. The Chat history feature can be closed by a user by clicking on a floating “X” or close button. Chat history can also be searched or sorted by user name, the Web site on which the Chat occurred, date, and keyword. In another embodiment, prior Chat text can be displayed as if on a virtual roll of paper, where the user can spin the “roll” forward and backward to search and read through Chat conversations.

In one embodiment, the Web browsers are enabled with JavaScript and utilize Asynchronous JavaScript and Xtensible Markup Language (AJAX) based requests to connect to the social relay servlets (FIG. 1 at 15) via pushlets. The social session and all Chat communication within the social session among the Web browsers are performed through functionality native to the Web browsers exclusively. The social session is transacted entirely through the standard default ports for HTTP (port 80) and HTTPS (port 443) communication Web protocols, and all communication is initiated by the Web browsers. This allows the social session to be accessed through any standard Web browser, through standard secure firewalls and without installation of applications, Web browser plug-ins including Java applets and Adobe Flash, ActiveX controls, security permissions, or signed scripts. The social session code is contained within a social session Web page, which is easily and automatically loaded simply by accessing the URL of the social session Web page. This ensures that the widest number of users and Web browsers can easily and automatically utilize the invention.

However, other implementations are possible, such as the installation of applications, Web browser plug-ins, or ActiveX controls, which can hold another port open over time to enable reuse. Chat text and boxes may be inserted directly into the HTML of a content Web page. Chat can be displayed on each user's Web browser without co-browse, i.e., where the Chat users are not on the same content Web page. In another embodiment, the Chat messages can be typed in a location other than the social session Web page. For example, if a Web browser plug-in is utilized, the messages can be typed in a Web browser toolbar or sidebar.

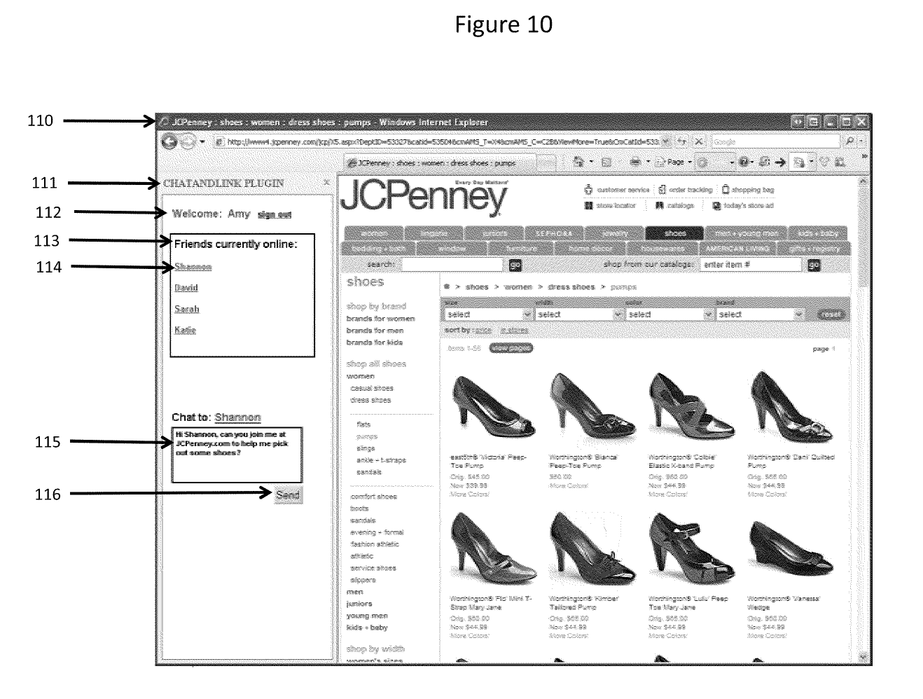

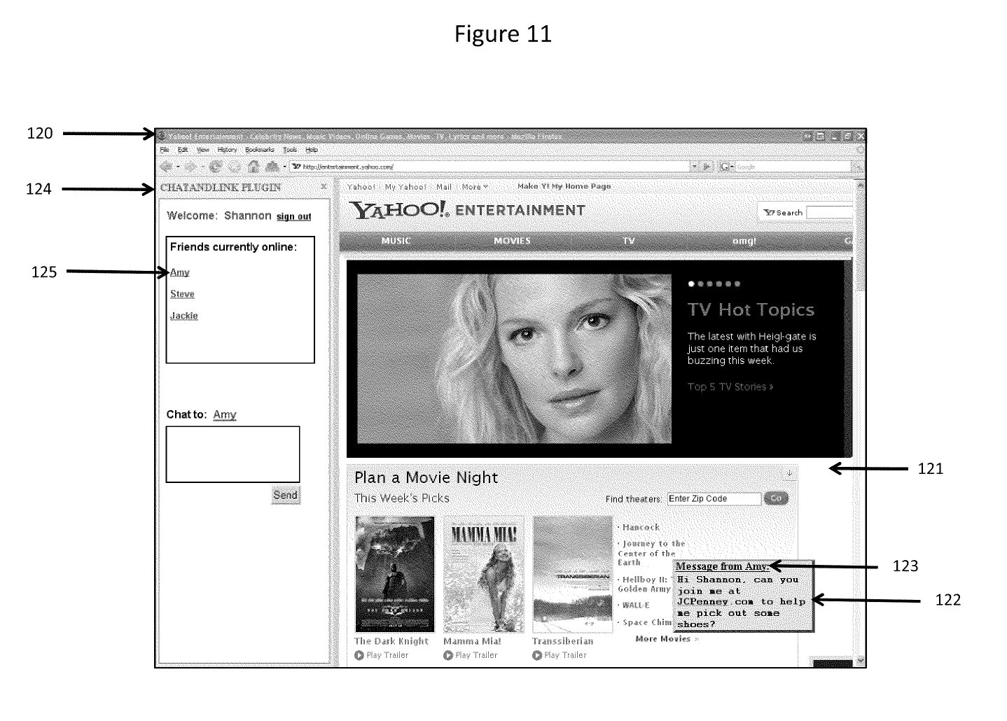

FIG. 10 is a screenshot which demonstrates Chat on a Web page utilizing a Web browser plug-in. In the example, two users, Amy and Shannon, have separately installed and activated the Web browser plug-in 111. Amy and Shannon need not be on the same Web page to start their Chat. The screenshot depicts Amy's Web browser 110. Amy checks the browser sidebar for friends currently online 113 and sees that Shannon 114 is online. Amy clicks on Shannon's name 114, which causes a text entry box 115 to be displayed. Amy types “Hi Shannon, can you join me at JCPenney.com to help me pick out some shoes?” and clicks “Send” 116. FIG. 11 is a screenshot of the action that follows on Shannon's Web browser 120. Amy's message 122 is displayed on the browser viewport on top of the Yahoo Web page 121 Shannon is currently viewing. Shannon clicks on Amy's name 123 in the message 122 or in the browser sidebar at 125, which brings Shannon to same Web page as Amy, where they can Chat about the shoes together. Although in the example, the Web browser sidebar 124 is open in Shannon's browser prior to her receiving the Chat message 122 from Amy, the browser sidebar instead may be initially closed, where Shannon opens it to respond to Amy's message 122 by an action such as clicking on Amy's name 123 in the Chat message.

The methods of the invention have widespread application in both the consumer and business fields. As demonstrated in the examples above, consumers can view Web pages together and engage in a Chat conversation regarding what they are looking at within the same viewable area of their Web browser. Consumers can utilize the invention to communicate with each other on Web pages while performing online activities together, such as shopping, viewing photos, a myriad of planning activities, and social networking.

Web businesses can utilize the invention to provide better customer service and sales support than is possible by Chat alone. A customer service/sales agent and a customer can discuss the page they are looking at on top of the Web page itself. As the agent or customer scrolls the Web page or navigates to a new Web page, the Chat conversation continues uninterrupted, floating on top of the Web page. Chat can be delivered and implemented on a business's Web site via a proxy server solution ((i.e., a social session Web server, as described above and illustrated in FIG. 1 at 14). A customer service/sales agent and a customer who desire to participate in a Chat session can be redirected to the social session server. The social session server loads a social session Web page in the agent's and customer's Web browsers. The social session Web page in turn displays the desired content Web page from the business's Web site, together with Chat text. By utilizing the proxy server solution, a business can thereby implement Chat directly on its Web site without installing complex software on its Web site servers or on the computers of its customer service/sales agents. A customer participating in the Chat session likewise need not download or install any software.

While the invention has been particularly shown and described as referenced to the embodiments thereof, those skilled in the art will understand that the foregoing and other changes in form and detail may be made therein without departing from the spirit and scope of the invention.

1. A method for providing chat on a Web page, where the chat text and the Web page content are displayed together in the same viewable area within a Web browser, comprising:
Establishing a communication session comprising a plurality of Web browsers;
Displaying the chat text on top of the Web content in the Web browser;
Transmitting the chat text to each other of the Web browsers;
Reproducing the chat text in each other of the Web browsers;
Moving the chat text to another area of the Web browser viewport when a user moves his or her mouse nearby the area containing the chat text, or otherwise interacts with the Web content beneath it;
Transmitting the chat movement data to each other of the Web browsers; and
Reproducing the chat text movement in each other of the Web browsers.
